(19) United States
(12) Patent Application Publication
(10) Pub. No.: US 2022/0170529 A1
(43) Pub. Date: Jun. 2, 2022

(54) PRESSURE PIECE WITH AN OPTIMISED THICKNESS RATIO, AND PLATE-LINK CHAIN COMPRISING A PRESSURE PIECE

(71) Applicant: Schaeffler Technologies AG & Co. KG, Herzogenaurach (DE)

(72) Inventors: Pascal Fritz, Bühl (DE); Manuel Falk, Baden Baden (DE)

(73) Assignee: Schaeffler Technologies AG & Co. KG, Herzogenaurach (DE)

(21) Appl. No.: 17/442,159

(22) PCT Filed: Mar. 23, 2020
(86) PCT No.: PCT/DE2020/100228

§ 371 Date: Sep. 23, 2021

(30) Foreign Application Priority Data
Apr. 23, 2019 (DE) 10 2019 110 493.9

(51) Int. Cl. F16G 5/18; F16H 9/24

(52) U.S. Cl. CPC F16G 5/18; F16H 9/24

(57) ABSTRACT

A pressure piece for articulated connection of links of a CVT plate-link chain for a drive train of a motor vehicle includes a center, a pressure piece lower portion with a lower thickness, a pressure piece upper portion with an upper thickness, and a thickness ratio between the lower thickness and the upper thickness. The lower thickness is measured at a predefined distance below the center when viewed in a vertical direction, and is measured perpendicular to the vertical direction. The upper thickness is measured at the predefined distance above the center when viewed in the vertical direction, and is measured perpendicular to the vertical direction. The thickness ratio is greater than 1/1.09.

### CROSS-REFERENCE TO RELATED APPLICATIONS

This application is the United States National Phase of PCT Appln. No. PCT/DE2020/100228 filed Mar. 23, 2020, which claims priority to German Application No. DE102019110493.9 filed Apr. 23, 2019, the entire disclosures of which are incorporated by reference herein.

### TECHNICAL FIELD

The present disclosure relates to a pressure piece for the articulated connection of links of a CVT plate-link chain for a drive train of a motor vehicle, e.g., for a continuously variable transmission (CVT transmission). The present disclosure also relates to a plate-link chain for a drive train of a motor vehicle having a plurality of links which are connected in an articulated manner via pressure pieces, e.g., via several pressure pieces which are arranged in pairs, and which engage in openings in the links.

### BACKGROUND

Pressure pieces and plate-link chains having pressure pieces are known from the prior art. For example, EP 1 862 700 A1 discloses a plate-link chain for, in particular, a vehicle drive, having a plurality of links articulated to one another via pressure pieces. The pressure pieces run transversely to the longitudinal direction of the plate-link chains and are arranged in openings in the links. The pressure pieces and the links have respective curved contact surfaces that rest against each other for power transmission. The pressure pieces have curved rolling surfaces that roll against each other for power transmission and end faces for frictional contact with conical pulleys of a conical pulley belt transmission. The end faces are configured in such a way that there is contact between the pressure pieces and the conical disks in the pressure piece vertical direction in the upper region of the end face.

However, in addition to the development of noise and strength, the efficiency and wear of a prior art plate-link chain and the implementation of a small running radius do not yet meet the high requirements. In the case of a plate-link chain, the installation space in the lower chain half is more restricted than the installation space in the upper chain half due to the kinking kinematics. Therefore, the pressure pieces for connecting the links in the lower half of the chain are made thinner than at the top. However, this has the disadvantage that the lower areas of the pressure pieces are more heavily loaded than the upper areas due to their reduced cross-section.

### SUMMARY

A (rocker) pressure piece and a link chain with such a pressure piece are provided in which the pressure piece is designed in such a way that kinking kinematics is enabled and at the same time a low load on the pressure piece is achieved. For example, an optimal cross-sectional ratio, e.g., thickness ratio, of the upper and lower cross-sectional halves of the pressure piece should be provided to achieve low utilization of this and to keep the installation space of the lateral strap brackets sufficiently large.

A generic device according to the disclosure has a thickness ratio of the pressure piece between a lower thickness of a portion of the pressure piece that is lower in a vertical direction and an upper thickness of a portion of the pressure piece that is higher in the vertical direction, the lower thickness and the upper thickness respectively viewed at a predefined distance from the center of the pressure piece in the vertical direction and measured perpendicular to said vertical direction, is greater than 1/1.09. In other words, the upper thickness is a maximum of 1.09 times the lower thickness.

The optimized cross-sectional ratio of the upper and lower pressure piece halves results in a reduced load on the pressure piece. Thus, a sufficiently high strength is provided for the lower portion. Due to the optimized thickness ratio, the strength of the lower portion is only slightly reduced compared to the upper portion, so that the pressure piece can also be used to transmit high torques.

The pressure piece may have a rolling surface, the rolling surface being symmetrical to the center viewed in the vertical direction. That is, the height and the thickness of the pressure piece are measured when the pressure piece is aligned so that an included upper angle between the rolling surface of the upper portion and a contour line that runs through the center, viewed in the vertical direction and aligned parallel to said vertical direction, corresponds to a lower angle that is included between the rolling surface of the lower portion and the contour line. That is, when measuring the thickness and the height, the pressure piece is oriented so that the rolling surface extends from the center, viewed in the vertical direction, at the same angle to said vertical direction in the upward direction and in the downward direction.

In an example embodiment, the thickness ratio can be less than or equal to 1/1.0, e.g., less than 1/1.05. That is, the depth of the lower portion is less than the depth of the upper portion. As a result, sufficient installation space is made available to enable the plate-link chain to be kinked even with a small running radius.

According to an example embodiment, the predefined distance can be less than 40% of the total height of the pressure piece. Since the thickness ratio is important in an area close to the center in an area which is remote from a contact area between the link and the pressure piece, it is advisable not to measure the thicknesses in the outer areas.

The predefined distance may be 20% to 35% of the total height of the pressure piece. The thickness ratio may be decisive in this area. An example embodiment has a thickness ratio which is between 1 and 1/1.09, e.g., 1/1.071, at a distance of about 30%±5% of the total height, e.g., exactly 30% of the total height.

A cross-section of the pressure piece may be constant in a longitudinal extension of the pressure piece. As a result, the optimum thickness ratio may be maintained over the entire width of the plate-link chain in which the pressure piece is used.

The present disclosure also includes a link chain for a drive train of a motor vehicle, e.g., for a continuously variable transmission. The plate-link chain has a multiplicity of links which are articulated to one another via at least one pressure piece which engages in openings in the links.

In other words, the disclosure relates to a pressure piece with an optimal cross-sectional ratio, e.g., a thickness ratio, between the upper and the lower pressure piece half in order to achieve a low load on the pressure piece. The center of the pressure piece seen in the vertical direction, which can also be referred to as a geometric center in said vertical direction, is determined based on the total height of the pressure piece when the pressure piece is in a symmetrical position with respect to the rolling side. For example, with a length of 30% of the total height from the center seen in the vertical direction, an optimal thickness ratio of lower thickness to upper thickness of 1:1.0-1.09 results.

### BRIEF DESCRIPTION OF THE DRAWINGS

The disclosure is explained below with the aid of drawings. In the figures:

FIG. 1 shows a portion of an exemplary general embodiment of a plate-link chain, and

FIG. 2 shows a schematic cross-sectional view of a pressure piece of the plate-link chain.

### DETAILED DESCRIPTION

The figures are only schematic in nature and serve only for understanding the disclosure. The same elements are provided with the same reference symbols.

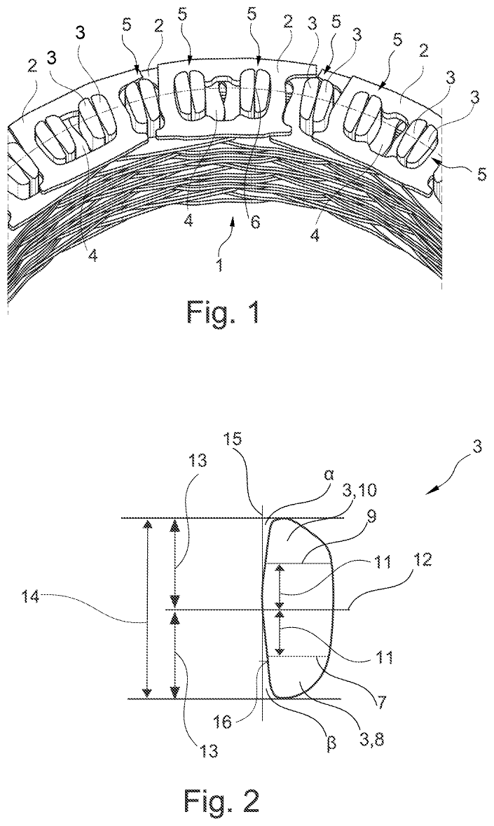

FIG. 1 shows a portion of an exemplary general embodiment of a plate-link chain 1 for a drive train of a motor vehicle. The plate-link chain 1 may be used for a continuously variable transmission (CVT transmission). For example, the plate-link chain 1 serves as a traction means of a variator in order to connect two cone pulley pairs of the variator to one another. The plate-link chain 1 has a large number of links 2, which are referred to below as links 2. The links 2 are arranged to be parallel to a running direction of the plate-link chain 1. The links 2 are arranged in multiple rows which are arranged next to one another with respect to the running direction of the plate-link chain 1. The links 2 are articulated to one another via rocker pressure pieces 3, which are referred to below as pressure pieces 3. The pressure pieces 3 engage in openings 4 of the links 2 or reach through the openings 4 in order to connect them to one another. The pressure pieces 3 extend transversely to the running direction of the plate-link chain 1. The pressure pieces 3 extend over the entire width of the plate-link chain 1. The pressure pieces 3 connect adjacent straps 2 to one another transversely to the running direction.

The links 2 of one row are offset in the running direction of the plate-link chain 1 in relation to the links 2 of another row, so that the links 2 are connected to one another by the pressure pieces 3 in the running direction of the plate-link chain 1. The pressure pieces 3 are each arranged in pairs as a pressure piece pair 5. Each link 2 is connected by a first pair of pressure pieces to a link 2 located in front of it in the running direction (or to several links 2 located in front of it in the running direction). Each link 2 is connected by a second pair of pressure pieces to a link 2 located behind it in the running direction (or to several links 2 located behind it in the running direction).

In a non-bent state of the plate-link chain 1, the pressure pieces 3 of a pressure piece pair 5 rest against one another at a rolling point 6. The pressure pieces 3 of a pressure piece pair 5 roll against one another at the rolling point 6 when the plate-link chain 1 is guided over a radius and is thereby curved.

FIG. 2 shows a schematic illustration of the pressure piece 3 according to the disclosure. The design of the pressure piece 3 according to the disclosure is described in more detail with reference to FIG. 2.

According to the disclosure, a thickness ratio of the pressure piece 3 between a lower thickness 7 of a portion 8 of the pressure piece 3 which is lower in a vertical direction and an upper thickness 9 of a portion 10 of the pressure piece 3 that is higher in the vertical direction is greater than 1/1.09. The thicknesses 7, 9 are each measured at a predefined distance 11 from the center 12 of the pressure piece 3, seen in the vertical direction, and perpendicular to said vertical direction in a thickness direction of the pressure piece 3. The vertical direction corresponds to the direction in which the pressure piece 3 has a maximum extent. The maximum extent is measured, for example, in a symmetrical position of the pressure piece 3, which will be explained in more detail later. The thickness direction of the pressure piece 3 is perpendicular to the vertical direction. This means that the center 12 viewed in the vertical direction is at half a height 13 of a total extension 14 in said vertical direction/total height 14. The vertical direction runs parallel to a height contour 15, which is shown in FIG. 2. The thickness direction runs parallel to the line of the center 12, seen in the vertical direction, which is shown in FIG. 2.

This means that the upper thickness 9 is a maximum of 1.09 times as large as the lower thickness 7. The thickness ratio between the lower thickness 7 and the upper thickness 9 is less than or equal to 1/1. This means that the lower thickness 7 is smaller than the upper thickness 9. The thickness ratio (lower depth/upper depth) is therefore between 1/1.09 (˜0.9174) and 1. Since the extension in the thickness direction of the pressure piece 3 changes greatly over the vertical direction, the lower thickness 7 and the upper thickness 9 are each measured at the same distance from the center 12 as seen in the vertical direction. The thicknesses 7, 9 are measured, for example, in an area in which the thickness 7, 9 is approximately constant in an area remote from a contact area between the pressure piece 3 and the link 2, in the direction towards the center.

In the embodiment, the predefined distance 11 is less than 40% of the total height 14 of the pressure piece 3. For example, the predefined distance 11 may be 20% to 35% of the total height of the pressure piece 3. For example, the predefined distance may be approximately 30%±5%, e.g., exactly 30%, of the total height 14.

In the embodiment shown, the thickness ratio is less than 1/1.05. More precisely, the thickness ratio in the predefined distance 11 of 30% of the total height 14 is 1/1.071. This has proven to be suitable for loading the pressure piece 3.

In FIG. 2, a cross-section of the pressure piece 3 is shown. The cross-section of the pressure piece 3 is constant in a longitudinal extension of the pressure piece 3, i.e., perpendicular to the cross-section.

The pressure piece 3 has a rolling surface 16 with which it rests on another pressure piece 3, which forms a pressure piece pair 5 with the pressure piece (see FIG. 1). In this case, an upper angle α, which is enclosed between the rolling surface 16 of the upper portion 10 and the contour line 15, which runs through the center viewed in the vertical direction and is aligned parallel to said vertical direction, and a lower angle β, which is included between the rolling surface 16 of the lower portion 8 and the contour line 15, are formed. In FIG. 2, the pressure piece 3 is shown in a symmetrical position in which the upper angle α corresponds to the lower angle β. This means that the total height 14, the lower depth 7 and/or the upper depth 9 of the pressure piece 3 are measured in the symmetrical position in which the rolling surface 16 is aligned symmetrically to the center 12 viewed in the vertical direction.

### REFERENCE NUMERALS

1 Plate-link chain
2 Link
3 Pressure piece
4 Opening
5 Pair of pressure pieces
6 Rolling point
7 Lower thickness
8 Lower portion
9 Upper thickness
10 Upper portion
11 Predefined portion
12 Center
13 Half height
14 Total height
15 Contour line
α upper angle
β lower angle

1.-8.(canceled)

9. A pressure piece for articulated connection of links of a CVT plate-link chain for a drive train of a motor vehicle, comprising:
a center;
a pressure piece lower portion comprising a lower thickness, the lower thickness:
measured at a predefined distance below the center when viewed in a vertical direction; and
measured perpendicular to the vertical direction;
a pressure piece upper portion comprising an upper thickness, the upper thickness:
measured at the predefined distance above the center when viewed in the vertical direction; and
measured perpendicular to the vertical direction; and
a thickness ratio between the lower thickness and the upper thickness, wherein the thickness ratio is greater than 1/1.09.

10. The pressure piece of claim 9 further comprising a rolling surface aligned symmetrically to the center when viewed in the vertical direction.

11. The pressure piece of claim 10 further comprising:
a contour line extending parallel to the vertical direction and through the center when viewed in the vertical direction;
an upper angle enclosed between a rolling surface upper portion and the contour line; and
a lower angle enclosed between a rolling surface lower portion and the contour line, wherein the pressure piece is aligned such that the upper angle and the lower angle are equal when the lower thickness and the upper thickness are measured.

12. The pressure piece of claim 9, wherein the thickness ratio is less than or equal to 1.

13. The pressure piece of claim 9 further comprising a total height when viewed in the vertical direction, wherein the predefined distance is 30% of the total height.

14. The pressure piece of claim 9, wherein a cross-section of the pressure piece is constant in a longitudinal extension of the pressure piece.

15. The pressure piece of claim 9, wherein the thickness ratio is between 1/1.05 and 1/1.09.

16. A CVT plate-link chain for a drive train of a motor vehicle, comprising:
a plurality of the pressure pieces of claim 9 arranged in pressure piece pairs;
a plurality of links, interconnected by the pressure piece pairs, wherein:
each of the plurality of links comprises an outer longitudinal bracket, an inner longitudinal bracket, and a pair of transverse brackets;
the pair of transverse brackets connects the outer longitudinal bracket to the inner longitudinal bracket to form a receiving opening; and
a one of the pressure piece pairs is disposed in the receiving opening.
